(19) United States
(12) Patent Application Publication
(10) Pub. No.: US 2015/0289513 A1
(43) Pub. Date: Oct. 15, 2015

(54) USE OF A COMPOUND COMPRISING A POLYFLUOROBENZYL MOIETY AGAINST INSECTICIDE-RESISTANT PESTS

(71) Applicant: BAYER CROPSCIENCE AG, Monheim (DE)

(72) Inventors: Sebastian Horstmann, Leverkusen (DE); Rainer Sonneck, Leverkusen (DE); Robert Velten, Langenfeld (DE); Stefan Werner, Berlin (DE)

(73) Assignee: BAYER CROPSCIENCE AG, Monheim (DE)

(21) Appl. No.: 14/441,662

(22) PCT Filed: Nov. 21, 2013
(86) PCT No.: PCT/EP2013/074383

§ 371 Date: May 8, 2015

(30) Foreign Application Priority Data
Nov. 23, 2012 (EP) 12194056.3

(51) Int. Cl. A01N 53/00; A01N 25/08

(52) U.S. Cl. CPC A01N 53/00; A01N 25/08

(57) ABSTRACT

The invention is in the technical field of insect control and relates to the use of a compound comprising a polyfluorobenzyl moiety for controlling insecticide-resistant pests such as mosquitoes and bed bugs.

The invention is in the technical field of insect control and relates to the use of a compound comprising a polyfluorobenzyl moiety for controlling insecticide-resistant pests such as mosquitoes and bed bugs.

Todays main insecticides used for vector control (including mosquitoes and bed bugs) relate to four chemical classes: pyrethroids, organochlorines (including DDT), organophosphates and carbamates. The use of pyrethroids far exceeds that of the other three classes due to its rapid and durable effect and its low toxicity and costs. However, recently resistance against pyrethroids have been reported which causes major concerns for the World Health Organisation and solutions how to tackle the emerging resistance are seen as to be of critical importance for the future vector control management (see e.g. http://www.who.int/malaria/world_malaria_report_{—}2011/WMR2011_chapter4.pdf).

Two main mechanisms of insecticide resistance were identified: target site resistance and metabolic resistance. Target site resistance occurs when the site of action of an insecticide is modified in mosquito populations so that the insecticide no longer binds effectively and the insect is therefore unaffected, or less affected, by the insecticide. Target site resistant mutations can affect acetylcholinesterase, which is the molecular target of organophosphates and carbamates, voltage-gated sodium channels (for pyrethroids and DDT), which is known as knock-down resistance (kdr), or the GABA receptor (for Dieldrin), which is known as resistance to Dieldrin (Rdl). Metabolic resistance occurs when increased levels or modified activities of a detoxifying enzyme system (such as esterases, monooxygenases or glutathione S-transferases (GST)) prevent the insecticide from reaching its intended site of action. Both mechanisms of resistances can be found in the same vector populations and sometimes within the same vector. Metabolic resistance, however, seems to be the stronger resistance mechanism and is therefore of greater concern.

Pyrethroids are the only insecticides that have obtained WHO recommendation against Malaria vectors or both Indoor Residuals Sprays (IRS) and Long Lasting Insecticidal Mosquito Nets (LLINs), in the form of Alpha-Cypermethrin, Bifenthrin, Cyfluthrin, Permethrin, Deltamethrin, Lambda-Cyhalothrin and Etofenprox. It has been the chemical class of choice in agriculture and public health applications over the last several decades because of its relatively low toxicity to humans, rapid knock-down effect, relative longevity (duration of 3-6 months when used as IRS), and low cost. However, massive use of pyrethroids in agricultural applications and for vector control led to the development of resistance in major malaria and dengue vectors. Strong resistance has e.g. been reported for the pyrethroid Deltamethrin (and Permethrin) for the Anopheles gambiae Tiassalé (from southern Côte d'Ivoire) strain (Constant V. A. Edi et al., Emerging Infectious Diseases; Vol. 18, No. 9, September 2012). Pyrethroid resistance was also reported for Permethrin, Deltamethrin and Lambda-Cyhalothrin for the Aedes aegypti Cayman Island strain (Angela F. Harris et al., Am. J. Trop. Med. Hyg., 83(2), 2010) and Alpha-Cypermethrin, Permethrin and Lambda-Cyhalothrin for certain Anopheles strains (Win Van Bortel, Malaria Journal, 2008, 7:102).

Bed bug control has (again) become a major task as a resurgence of bed bug infestations has occurred over the last 10 years. In this connection, it has also been reported that these insects have developed resistance to pyrethroids such as Deltamethrin and Beta-Cyfluthrin (Zach N. Adelman et al, PloS ONE, October 2011, Vol 6, Issue 10).

Due to the emerging resistance in mosquitoes and bed bugs against certain pyrethroids there is an ongoing need for alternative solutions and strategies for vector and bed bug control management. With the present invention it has now been surprisingly found that compounds comprising a polyfluorobenzyl moiety such as Transfluthrin, Metofluthrin, Momfluorothrin, Meperfluthrin, Dimefluthrin, Fenfluthrin, Profluthrin, Tefluthrin or Heptafluthrin are useful for the to control of insecticide-resistant pests such as mosquitoes and bed bugs.

Transfluthrin (IUPAC name: (1R,3S)-3-(2,2-Dichlorovinyl)-2,2-dimethyl-1-cyclopropanecarboxylic acid (2,3,5,6-tetrafluorophenyl)methyl ester) is a pyrethroid insecticide mainly known for consumer use against flies, mosquitoes and moths. This chemical is a volatile substance and acts as a contact and inhalation agent.

DE 199 47 146 A1 discloses the use of Transfluthrin impregnated textile carriers to control insects. Table 1 shows the insecticidal activity of Transfluthrin against Aedes aegypti (susceptible) and Culex quingefasciatus (DDT-resistent). DE 199 47 146 A1 does not disclose the use of Transfluthrin or Metofluthrin alone (without an additional insecticide) against insecticidal-resistant Aedes aegypti and also not the use of Transfluthrin or Metofluthrin to control insecticide-resistant mosquitoes that are resistant against at least one insecticide selected from the group of pyrethroids, carbamates and organophosphates.

EP 2 201 841 A1 discloses synergistic combinations with Transfluthrin, Thiacloprid or Acetamiprid and an additional insecticide and/or fungicide. The combinations are mentioned to be active also against resistant Aedes spp., Anopheles spp. or Culex spp. This reference, however, does not disclose that Transfluthrin or Metofluthrin alone (without an additional insecticide) can be used to control insecticidal-resistant mosquitoes and/or bed bugs.

WO2011/003845 A2 discloses a composition comprising chlorfenapyr, a pyrethroid (e.g. Transfluthrin or Metofluthrin) and a special acrylate binder for the impregnation of substrates such as a mosquito net. Table 3 on page 22 depicts the insecticidal activity of a mosquito net impregnated with the composition according to the invention against pyrethroid-resistant Aedes aegypti and pyrethroid-resistant Anopheles gambiae. Also this reference does not disclose that Transfluthrin or Metofluthrin alone (without an additional insecticide) can be used to control insecticidal-resistant mosquitoes.

In summary, Transfluthrin is not known to be useful for vector resistance management applications. In particular, it is not known that Transfluthrin (in particular alone and not in combination with an additional insecticide) can be used against insecticide-resistant pests such such as mosquitoes and/or bed bugs that have developed a resistance against at least one pyrethroid compound. Efficacy of various pyrethroid structures such as Transfluthrin against a metabolically resistant strain of Helicoverpa armigera was described (Jianguo Tan et al., Pest Management Science; 63:960-968, 2007). However, Jianguo Tan et al. is not relevant for the present invention as it discusses resistance mechanisms in Helicoverpa armigera and not mosquitoes and bed bugs.

Metofluthrin (IUPAC name: 2,3,5,6-Tetrafluoro-4-(methoxymethyl)benzyl 2,2-dimethyl-3-(prop-1-en-1-yl)cyclopropanecarboxylate) is a pyrethroid insecticide known for the use as a household insecticide such as Transfluthrin. Metofluthrin is not known to be useful for vector resistance management. In particular, it is not known that Metofluthrin can be used against insecticide-resistant pests such as mosquitoes and/or bed bugs that have developed a resistance against at least one pyrethroid compound. Transfluthrin, Metofluthrin and Tefluthrin (IUPAC name: 2,3,5,6-tetrafluoro-4-methylbenzyl-Z-(1RS,3RS)-(2-chloro-3,3,3-trifluorprop-1-enyl)-2,2-dimethylcyclopropanecarboxylate) are also e.g. described in the Pesticide Manual, 15th edition (2011), the British Crop Protection Council, London.

Dimefluthrin (IUPAC name: 2,3,5,6-tetrafluoro-4-(methoxymethyl)benzyl (1RS,3RS,1RS,3SR) 2,2-dimethyl-3-(2-methylprop-1-enyl)cyclopropanecarboxylate) is another pyrethroid insecticide comprising a polyfluorobenzyl moiety and is known for use as a household and public health insecticide (see also EP01004569A1). Fenfluthrin (IUPAC: 2,3,4,5,6-pentafluorobenzyl (1R,3S)-3-(2,2-dichlorovinyl)-2,2-dimethylcyclopropanecarboxylate or 2,3,4,5,6-pentafluorobenzyl (1R)-trans-3-(2,2-dichlorovinyl)-2,2-dimethylcyclopropanecarboxylate) and Profluthrin (IUPAC name: 2,3,5,6-tetrafluoro-4-methylbenzyl (EZ)-(1RS,3RS;1RS,3SR)-2,2-dimethyl-3-prop-1-enylcyclopropanecarboxylate or 2,3,5,6-tetrafluoro-4-methylbenzyl (EZ)-(1RS)-cis-trans-2,2-dimethyl-3-prop-1-enylcyclopropanecarboxylate) are also known pyrethroid compounds that have a polyfluorobenzyl moiety.

Momfluorothrin (IUPAC name: 2,3,5,6-Tetrafluoro-4-(methoxymethyl)benzyl 3-(2-cyano-1-propen-1-yl)-2,2-dimethylcyclopropanecarboxylate), Meperfluthrin (IUPAC name: 2,3,5,6-tetrafluoro-4-(methoxymethyl)benzyl (1,R,3S)-3-(2,2-dichlorovinyl)-2,2-dimethylcyclopropanecarboxylate; see also Chinese patent application no.: CN200910111805), Heptafluthrin (IUPAC name: 2,3,5,6-tetrafluoro-4-(methoxymethyl)phenyl]methyl2,2-dimethyl-3-(3,3,3-trifluoro-1-propen-1-yl)cyclopropanecarboxylate; see also WO2010/043122A1) are other pyrethroid insecticides comprising a polyfluorobenzyl moiety.

The insecticidal compound used according to the invention to control insecticide-resistant mosquitoes and/or bed bugs comprises a polyfluorobenzyl (preferably a tetrafluorobenzyl or pentafluorobenzyl and more preferably a tetraflurobenzyl) moiety and is preferably selected from the group of Transfluthrin, Metofluthrin, Momfluorothrin, Meperfluthrin, Dimefluthrin, Fenfluthrin, Profluthrin, Tefluthrin and Heptafluthrin (more preferably from Transfluthrin, Metofluthrin and Momfluorothrin, even more preferably from Transfuthrin and Metofuthrin and most preferably from Transfluthrin). These compounds (including all their preferred definitions) are herein also referred to as “active ingredient(s)”, “active compound(s)” or alternatively “(insecticidal) compound(s) comprising a polyfluorbenzyl moiety”.

In a particularly preferred embodiment an active ingredient is used alone (without any additional insecticide; preferably also not a combination of two different insecticidal compounds comprising a polyfluorobenzyl moiety) to control insecticide-resistant mosquitoes (and in particular pyrethroid-resistant mosquitoes) and also alone to control insecticide-resistant (an in particular pyrethroid-resistant) bed bugs. In the most preferred embodiment of the invention, only Transfluthrin alone (without an additional insecticide) is used to control insecticide-resistant (an in particular pyrethorid-resistant) mosquitoes and also alone to control insecticide-resistant (an in particular pyrethorid-resistant) bed bugs.

The term “insecticide-resistant mosquito” means a mosquito that is resistant to at least one insecticide selected from the group of pyrethroids, organophosphates and carbamates. In a preferred definition the term “insecticide-resistant mosquito” refers to a mosquito that is resistant to a least one insecticide selected from the group of pyrethroids (pyrethroids that do no comprise a polyfluorobenzyl moiety and preferably pyrethoids that do not comprise a tetrafluorobenzyl or pentafluorobenzyl moiety and more preferably pyrethroids that do not comprise a tetrafluorobenzyl moiety), organophospates and carbamates (preferably pyrethroids) but not—at the same time—to an organochlorine such as DDT. Pyrethroids in this connection refer more preferably to at least one compound selected from the group of Acrinathrin, Allethrin (d-cis-trans, d-trans), Beta-Cyfluthrin, Bifenthrin, Bioallethrin, Bioallethrin-S-cyclopentyl-isomer, Bioethanomethrin, Biopermethrin, Bioresmethrin, Chlovaporthrin, cis-Cypermethrin, cis-Resmethrin, cis-Permethrin, Clocythrin, Cycloprothrin, Cyfluthrin, Cyhalothrin, Cypermethrin (alpha-, beta-, theta-, zeta-), Cyphenothrin, Deltamethrin, Empenthrin (1R-isomer), Esfenvalerate, Etofenprox, Fenpropathrin, Fenpyrithrin, Fenvalerate, Flubrocythrinate, Flucythrinate, Flufenprox, Flumethrin, Fluvalinate, Fubfenprox, gamma-Cyhalothrin, Imiprothrin, Kadethrin, Lambda-Cyhalothrin, Permethrin (cis-, trans-), Phenothrin (1R-trans isomer), Prallethrin, Protrifenbute, Pyresmethrin, Resmethrin, RU 15525, Silafluofen, tau-Fluvalinate, Terallethrin, Tetramethrin (-1R-isomer), Tralomethrin, ZXI 8901 and Pyrethrin (pyrethrum).

Organophosphate refers preferably to a compound selected from the group of Acephate, Azamethiphos, Azinphos (-methyl, -ethyl), Bromophos-ethyl, Bromfenvinfos (-methyl), Butathiofos, Cadusafos, Carbophenothion, Chlorethoxyfos, Chlorfenvinphos, Chlormephos, Chlorpyrifos(-methyl/-ethyl), Coumaphos, Cyanofenphos, Cyanophos, Chlorfenvinphos, Demeton-S-methyl, Demeton-S-methylsulphon, Dialifos, Diazinon, Dichlofenthion, Dichlorvos/DDVP, Dicrotophos, Dimethoate, Dimethylvinphos, Dioxabenzofos, Disulfoton, EPN, Ethion, Ethoprophos, Etrimfos, Famphur, Fenamiphos, Fenitrothion, Fensulfothion, Fenthion, Flupyrazofos, Fonofos, Formothion, Fosmethilan, Fosthiazate, Heptenophos, Iodofenphos, Iprobenfos, Isazofos, Isofenphos, Isopropyl O-Salicylate, Isoxathion, Malathion, Mecarbam, Methacrifos, Methamidophos, Methidathion, Mevinphos, Monocrotophos, Naled, Omethoate, Oxydemeton-methyl, Parathion (-methyl/-ethyl), Phenthoate, Phorate, Phosalone, Phosmet, Phosphamidon, Phosphocarb, Phoxim, Pirimiphos (-methyl/-ethyl), Profenofos, Propaphos, Propetamphos, Prothiofos, Prothoate, Pyraclofos, Pyridaphenthion, Pyridathion, Quinalphos, Sebufos, Sulfotep, Sulprofos, Tebupirimfos, Temephos, Terbufos, Tetrachlorvinphos, Thiometon, Triazophos, Triclorfon and Vamidothion. In a more preferred embodiment, the term organophosphate refers to a compound selected from the group of Acephate, Chlorpyrifos, Dimethoate, Diazinon, Malathion, Methamidophos, Monocrotophos, Parathion-methyl, Profenofos and Terbufos.

Carbamate refers to a compound selected from the group of Alanycarb, Aldicarb, Aldoxycarb, Allyxycarb, Aminocarb, Bendiocarb, Benfuracarb, Bufencarb, Butacarb, Butocarboxim, Butoxycarboxim, Carbaryl, Carbofuran, Carbosulfan, Cloethocarb, Dimetilan, Ethiofencarb, Fenobucarb, Fenothiocarb, Formetanate, Furathiocarb, Isoprocarb, Metam-sodium, Methiocarb, Methomyl, Metolcarb, Oxamyl, Pirimicarb, Promecarb, Propoxur, Thiodicarb, Thiofanox, Trimethacarb, XMC, Xylylcarb and Triazamate. In a more preferred embodiment, the term “carbamate” refers to a compound selected from the group of Aldicarb, Benfuracarb, Carbaryl, Carbofuran, Carbosulfan, Fenobucarb, Methiocarb, Methomyl, Oxamyl, Thiodicarb and Triazamate.

The term “insecticide-resistant bed bug” further means a bed bug that is resistant to at least one insecticide selected from the group of pyrethroids, organochlorines (including DDT), organophosphates and carbamates. Preferred pyrethroids, organophosphates and carbamates are the same as defined above for the term “insecticide-resistant mosquitoes”. Organochlorine in this connection refers preferably to a compound selected from the group of DDT (Dichlorodiphenyltrichloroethane), Chlordane, Endosulfan, Dieldrin and Lindane, more preferably to DDT alone.

In a more preferred embodiment of the invention, an active ingredient of the invention is used to control insecticide-resistant pests and preferably mosquitoes and/or bed bugs that are resistant against at least one pyrethroid insecticide. In this connection the pyrethroid resistance is against one pyrethroid as defined above. In a more preferred embodiment the term “pyrethroid” refers to a compound selected from the group of Alpha-Cypermethrin, Bifenthrin, Cyfluthrin, Cypermethrin, Deltamethrin, D-D Trans-Cyphenothrin Esfenvalerate, Etofenprox, Lambda-Cyhalothrin, Permethrin, Pyrethrins (Pyrethrum), Phenothrin and Zeta-Cypermethrin. In a preferred embodiment pyrethroid resistance exists in regard to at least one pyrethroid selected from the group of Cyfluthrin, Cypermethrin, Deltamethrin, Lambda-Cyhalothrin, Permethrin. In a more preferred embodiment pyrethroid resistance exists in regard to at least one pyrethroid selected from the group of Cyfluthrin, Cypermethrin, Permethrin; more preferably against at least Cypermethrin.

In another preferred embodiment of the invention and active ingredient is used to control multi-resistant mosquitoes and/or bed bugs. Multi-resistant mosquitoes refers to a mosquitoes and/or bed bugs where several different resistance mechanisms are present simultaneously such as target-site resistance and metabolic resistance. The different resistance mechanisms may combine to provide resistance to multiple classes of products (IRAC publication: “Preventation and Management of Insecticide Resistance in Vectors of Public Health Importance”; second edition; 2011).

The term “insecticide-resistance” is the term used to describe the situation in which the vectors are no longer killed by the standard dose of insecticide (they are no longer susceptible to the insecticide) or manage to avoid coming into contact with the insecticide). See 1.2; p. 27; “Global Plan for Insecticide Resistance Management”, WHO 2012). The term vector in this connext refers to a mosquito and/or bed bug.

As an example, WHO recommended standard dose of insecticide for indoor residual treatment against mosquito vectors are: Alpha-Cypermethrin 20-30 mg/m², Bifenthrin 25-50 mg/m², Cyfluthrin 20-50 mg/m², Deltamethrin 20-25 mg/m², Etofenprox 100-300 mg/m², Lambda-Cyhalothrin 20-30 mg/m² (http://www.who.int/whopes/Insecticides_IRS_Malaria_{—}09.pdf). WHO recommended standard dose of insecticide products treatment of nets for malaria vector control are: Alpha-Cypermethrin 20-40 mg/m², Cyfluthrin 50 mg/m², Deltamethrin 15-25 mg/m², Etofenprox 200 mg/m², Lambda-Cyhalothrin 10-15 mg/m², Permethrin 200-500 mg/m² (http://www.who.int/whopes/Insecticides_ITN_Malaria_ok3.pdf). WHO recommended standard dose for space spraying against mosquitoes are described in the publication: http://www.who.int/whopes/Insecticides_for_space_spraying_Jul_{—}2012.pdf. WHO recommended insecticide doses for bed bug control are e.g. for Deltamethrin 0.3-0.5 g/l or g/kg; Cyfluthrin 0.4 g/l or g/kg; Cypermethrin 0.5-2.0 g/l or g/kg; Permethrin 1.25 g/l or g/kg etc. (see Pesticides and their Application, WHO 2006; WHO/CDS/NTD/WHOPES/GCDPP/2006.1).

The term “control” insecticide-resistant mosquitoes and/or bed bugs refers to the possibility to be able to kill and/or repell mosquitoes and/or bed bugs that are insecticide-resistant (in order to avoid the biting of humans and transmission of the vectors to humans).

In a preferred embodiment of the invention the insecticide-resistant mosquitoes are selected from the group of Anopheles gambiae, Anopheles funestus, Aedes aegypti and Culex spp. In another preferred embodiment of the invention an active ingredient is used against insecticide-resistant mosquitoes that are selected from the group of Anopheles gambiae RSPH, Anopheles gambiae Tiassalé, Anopheles gambiae Akron, Anopheles gambiae VK7, Anopheles funestus FUMOZ-R, Aedes aegypti Grand Cayman and Culex quinquefasciatus strain P00.

Anopheles gambiae, strain RSPH is a multi-resistant mosquito (target-site and metabolic-resistance) that is described in the reagent catalog of the Malaria Research and Reference Reagent Resource Center (www.MR4.org; MR4-number: MRA-334).

Anopheles gambiae, strain Tiassalé is a multi-resistant mosquito (target and metabolic-resistant strain) which shows cross-resistance between carbamates, organophosphates and pyrethroids and is described in Constant V. A. Edi et al., Emerging Infectious Diseases; Vol. 18, No. 9, September 2012 & Ludovic P Ahoua Alou et al., Malaria Journal 9:167, 2010).

Anopheles gambiae, strain Akron is a multi-resistant mosquito (target and metabolic-resistant strain) and is described in Djouaka F Rousseau et al., BMC Genomics, 9:538; 2008.

Anopheles gambiae, strain VK7 is a target-resistant mosquito and is described in Dabiré Roch Kounbobr et al., Malaria Journal, 7:188, 2008.

Anopheles funestus, strain FUMOZ-R is a metabolic-resistant strain and is described in Hunt et al., Med Vet Entomol. 2005 September; 19(3):271-5). In this article it has been reported that Anopheles funestus—as one of the major malaria vector mosquitoes in Africa—showed resistance to pyrethroids and carbamate insecticides in South Africa.

Aedes aegypti, strain Grand Cayman is a target-resistant mosquito and is described in Angela F. Harris, Am. J. Tro. Med. Hyg. 83(2), 2010.

Culex quinquefasciatus (metabolic-resistant to DDT strain P00); received from Texchem, Penang, Malaysia.

In a preferred embodiment of the invention, an active ingredient is used for vector control. Vector control is the prevention of transmission of diseases by vector insects (such as Encephalitis, West Nile Virus, Dengue Fever, Malaria, Rift Valley Fever, Yellow Fever). Vector control methods vary considerably in their applicability, cost and sustainability of their results. In a preferred embodiment of the invention, vector control refers to Malaria and Dengue vector control. Vector insects in connection with the prevention of the transmission of diseases are preferably mosquitoes.

In another preferred embodiment, the invention also relates to the use of an active ingredient to control pyrethroid-resistant bed bugs. In a more preferred embodiment, an active compound of the invention is used to control pyrethroid-resistant bed bugs, wherein the bed bugs have a Valine to Leucine mutation (V419L) and/or a Leucine to Isoleucine mutation (L925I) in the voltage-gated sodium channel alpha-subunit gene. In a more preferred embodiment of the invention, an active ingredient is used against the insecticide-resistant bed bug (Cimex Lectularius) strain Cincinnati (CIN-1) (Fan Zhu et al., Archives of Insect Biochemistry and Physiology, 2010, Vol. 00, No 0, 1-13).

A skilled person in the art is fully aware that application rates for an active ingredient to control insecticide-resistant pests such as mosquitoes and/or bed bugs depend on various factors such as the formulation type, application form, the object/surface to be treated etc. However, as a general guidance the application rate for an active ingredient to control insecticide-resistant mosquitoes is preferably at least 5 mg/m², more preferably at least 15 mg/m² and most preferably at least 25 mg/m². For the control of insecticide-resistant bed bugs the application rate is preferably at least 100 mg/l or mg/kg and more preferably 300 mg/l or mg/kg.

In another preferred embodiment of the invention, it has been found that an active ingredient can also be used in an indoor residual spray, an insecticide treated net, a longer lasting insecticide net, space spray and/or spatial repellent to control insecticide-resistant mosquitoes.

Indoor residual sprays (IRS) according to the invention refer to formulations that are applied on walls and roofs of houses and domestic animal shelters in order to kill adult vector mosquitoes that land and rest on these surfaces. The primary effect of such sprays is towards curtailing malaria (and dengue) transmission by reducing the life span of vector mosquitoes so that they can no longer transmit the disease from one person to another and reducing the density of the vector mosquitoes.

Insecticide treated net (ITN) are mosquito nets or bednets impregnated with insecticides that are useful for vector control. However, only pyrethroid insecticides are approved for use on ITNs. There are several types of nets available. Nets may vary by size, material and/or treatment. Most nets are made of polyester but nets are also available in cotton, polyethylene, or polypropylene. Previously, nets had to be retreated every 6-12 months, more frequently if the nets were washed. Nets were retreated by simply dipping them in a mixture of water and insecticide and allowing them to dry in a shady place. WHO recommends various formulation for retreatment (see http://www.who.int/whopes/Insecticides_ITN_Malaria_ok3.pdf). The need for frequent retreatment was a major barrier to widespread use of ITNs in endemic countries. The additional cost of the insecticide and the lack of understanding of its importance resulted in very low retreatment rates in most African countries. More recently, several companies have developed long-lasting insecticide-treated nets (LLINs) that maintain effective levels of insecticide for at least 3 years.

Longer lasting insecticide net (LLINs) are nets that are treated at factory level by a process that binds or incorporates insecticides into the fibres. WHO recommended LLINs are made from polyester, polyethylene, polypropylene and compounds such as deltamethrin, alpha-cypermethrin, permethrin and PBO to increase efficacy (http://www.who.int/whopes/Long_lasting_insecticidal_nets_Jul_{—}2012.pdf).

In another embodiment of the invention ITN and LLINs made from polypropylene wherein an active ingredient is embedded are preferred. In particular such LLINs that are described in WO2009/121580A2, WO2011/128380A1, WO2011/141260A1.

Space sprays are liquid insecticidal formulations that can be dispersed into the air in the form of hundreds of millions of tiny droplets less than 50 μm in diameter. They are only effective while the droplets remain airborne. Space sprays are applied mainly as thermal fogs or cold fogs.

Spatial repellents, or area repellents (also known as deterrents) are defined as chemicals that work in the vapor phase to prevent human-vector contact by disrupting normal behavioural patterns within a designated area or “safe zone” (e.g. a space occupied by potential human hosts) thus making the space unsuitable for the insect.

According to another preferred embodiment of the invention, an active ingredient is used together with a base material.

In a preferred embodiment of the invention it has been found that an active ingredient can be used with a suitable base material selected from the group of a polymers such thermoplastics or thermosets; plant-based materials; coating/impregnation solutions and/or mixtures thereof to control insecticide-resistant pests.

According to the present invention polymers include synthetic polymers such as thermoplastics or thermosets. Thermosets, also known as a thermosoftening plastics, are polymers that turn to liquid when heated and freeze to a rigid state when cooled sufficiently. Most thermoplastics are high-molecular-weight polymers whose chains associate through weak Van der Waals forces (e.g. polyethylene); stronger dipole-dipole interactions and hydrogen bonding (e.g. nylon) or even stacking of aromatic rings (e.g. polystyrene). Thermoplastic polymers differ from thermosetting polymers (e.g. phenolics, epoxies) in that they can be remelted and remoulded. Many thermoplastic materials are addition polymers; e.g. vinyl chain-growth polymers such as polyethylene and polypropylene; others are productions of condensation or other forms of polyaddition polymerisation, such as the polyamides or polyester. Polymers such as thermoplastics and rubber polymers can be selected from the group of Acrylonitrile Butadiene Styrene (ABS), Acrylic (PMMA), Celluloid, Cellulose acetate, Cyclic Olefin Copolymer (COC), Ethylene-Vinyl Acetate (EVA), Ethylene Vinyl Alcohol (EVOH), Fluoroplastics (PTFE, alongside with FEP, PFA, CTFE, ECTFE, ETFE), Ionomers, Liquid Crystal Polymer (LCP), Polyoxymethylene (POM or Acetal), Polyacrylates (Acrylic), Polyacrylonitrile (PAN or Acrylonitrile), Polyamide (PA or Nylon), Polyamide-imide (PAI), Polyaryletherketone (PAEK or Ketone), Polybutadiene (PBD), Polybutylene (PB), Polybutylene Terephthalate (PBT), Polycaprolactone (PCL), Polychlorotrifluoroethylene (PCTFE), Polyethylene Terephthalate (PET), Polycyclohexylene dimethylene Terephthalate (PCT), Polycarbonate (PC), Polyhydroxyalkanoates (PHAs), Polyketone (PK), Polyester, Polyethylene (PE), Polyetheretherketone (PEEK), Polyetherketoneketone (PEKK), Polyetherimide (PEI), Polyethersulfone (PES), Chlorinated Polyethylene (CPE), Olyimide (PI), Polylactic Acid (PLA), Polymethylpentene (PMP), Polyphenylene Oxide (PPO), Polyphenylene Sulfide (PPS), Polyphthalamide (PPA), Polypropylene (PP), Polystyrene (PS), Polysulfone (PSU), Polytrimethylene terephthalate (PTT), Polyurethane (PU), Polyvinyl Acetate (PVA), Polyvinyl Chloride (PVC), Polyvinylidene Chloride (PVDC), Styrene-acrylonitrile (SAN).

In another preferred embodiment of the invention, an active ingredient is used together with polymers selected from the group of polyester, polyamide, polyolefins (such as polyethylene, polypropylene). Transfluthrin and/or Metofluthrin easily can be added during processing of the polymeric material. As the processing temperatures of common polymers such as thermoplastics are in a range of 130-320° C. (e.g. extrusion, compounding, film blowing, spinning, calendaring, foaming etc.), Transfluthrin and/or Metofluthrin might melt during processing as well and are solidifying together with the matrix polymer during cool-down giving a homogenous material compound containing the desired amount of insecticide. The addition of an active ingredient can also be done in a two-step process, with a concentrate (masterbatch) produced via mixing of the polymer with an active ingredient and a second processing step where the active ingredient is further diluted by adding additional polymers during processing. Manufactering processes of polymers (such as polypropylene etc.) with Transfluthrin was e.g. in more detailed described in WO97/29634.

The concentration of the active ingredient in (respectively on) polymers can be varied within a relatively wide concentration range (for example from 1% to 15% by weight). The concentration should be chosen according to the field of application such that the requirements concerning efficacy, durability and toxicity are met.

According to the present invention the term “thermoset” refers to a thermosetting plastic which is a polymer material that irreversibly cures. The cure may be done through heat (generally above 200° C. (392° F.)), through a chemical reaction (two-part epoxy, for example), or irradiation such as electron beam processing. Thermoset materials are usually liquid or malleable prior to curing and designed to be molded into their final form, or used as adhesives. Others are solids like that of the molding compound used in semiconductors and integrated circuits (IC). Once hardened a thermoset resin cannot be reheated and melted back to a liquid form. According to IUPAC recommendation: A thermosetting polymer is a prepolymer in a soft solid or viscous state that changes irreversibly into an infusible, insoluble polymer network by curing. Curing can be induced by the action of heat or suitable radiation, or both. A cured thermosetting polymer is called a thermoset. Some examples of thermosets are: Polyester fibreglass systems (sheet molding compounds and bulk molding compounds); vulcanized rubber; bakelite, a phenol-formaldehyde resin; duroplast; urea-formaldehyde foam; melamine resin; epoxy resin; polyimides; cyanate esters or polycyanurates.

The term “plant-based natural materials” refers to natural derived substrates/fibers such cellulose-based materials (paper/cardboard), cotton, sisal, jute, wood, flax, cotton, bamboo, hemp, wool etc.

For the production of polymers such as thermoplastics, thermosets or composite materials and mixtures thereof (e.g. thermoplastics mixed with other thermoplastics e.g. thermoplastics with plant-based natural materials) additional additives can be used such a e.g. metal deactivators, peroxide scavengers, basic costabilizers, nucleating agents, plasticizers, lubricants, UV-protecting agents, emulsifiers, pigments, viscosity modifiers, catalysts, flow control agents, optical brighteners, antistatic agents and blowing agents, benzofuranones and indolinones, fluorescent plasticizers, mould release agents, flame-retardant additives, synergists, antistatic agents such as sulphonate salts, pigments and also organic and inorganic dyes and also compounds containing epoxy groups or anhydride groups.

The term “coating/impregnation solution”, as used herein, shall refer to a solution that is later sprayed to form a coating, a part of a coating, or is used for impregnation and include the herein discussed active ingredients as well as other coating/impregnation solution components such as but not limited to solvents, polymers, oils, fats, natural resins, tensides, surfactants, emulgators, stabilizers, salts thickeners, fragrants, pigments and/or other additives. Coating/impregnation solutions are preferably liquid at room temperature (25° C.).

According to the present invention the term “coatings/impregnation” refers to a (preferably liquid) solution that is applied to the surface of an object, usually referred to as the substrate (which can also be a base material) or the object is dipped into the solution. In the context of the present invention, coatings or impregnation (e.g. in the form of a spray or solution) are preferably applied to walls floormats, sleeping mats, sacking or mattresses, made of sisal, cotton, wool, jute or other vegetable fibers) in order to control/kill/repell mosquitoes inside and outside of houses.

In another preferred embodiment the active ingredient(s) of the invention is/are preferably used with the base material in a concentration of below 50 weight percent (wt %), preferred below 30 wt %, more preferably below 20, and especially preferred below 15 wt % (the combination of the active ingredient and the base material equals 100 wt %).

The polymers of the present invention can be processed into miscellaneous products such as for example, filaments, fabrics, chips, pellets, pearls, foams, foils, pellets, plates, air-cushioning materials, films, nets, profiles, sheets, textiles, wires, threads, tapes, cable and pipe linings, casings for electrical instruments (for example in switch boxes, aircraft, refrigerators, etc.). Further examples are given herein below.

The polymers with an active ingredient as well as the threads, fibers, filaments, multifilaments, fabrics, wovens, nets etc. produced therefrom are very useful for controlling/killing insecticide-resistant mosquitoes. The manufacturing of such products is described in detail in e.g. WO2009/121580A2, WO2011/128380A1, WO2011/141260A1.

Polymers as well as plant-based materials together with the active ingredients of the invention can also be used to produce textiles. According to the present invention the term “textiles” is referring to a textile or cloth that is a flexible woven material consisting of a network of natural or artificial fibres often referred to as thread or yarn. Yarn is produced by spinning raw fibres of a plant-based material such as wool, flax, cotton, hemp, or other materials such as polymers to produce long strands. Textiles are formed by weaving, knitting, crocheting, knotting, or pressing fibres together. Such products can also be used to produce ITNs resp. LLINs.

Further products which can be made with the discussed base materials or onto which the coating/impregnation solutions of the invention can be applied include e.g. outdoor carpetings, outdoor furniture, window shades, curtains, outdoor coverings for tables, and other flat surfaces, patio decks, hulls, filtering, flags, backpacks, tents, nets, mosquito nets, transportation devices such as balloons, kites, sails, and parachutes; technical textiles such as geotextiles (reinforcement of embankments), agrotextiles (textiles for crop protection such as horticulture films), protective clothing, electrical insulation, insulation for buildings etc.

A preferred embodiment of the invention are an ITN and/or LLIN (preferably a LLIN) produced from polymers selected from the group of polyolefins (polyethylene, polypropylene and the like), polyesters (polyethylenterephthalates and the like) and polyamides. Preferably the ITN and/or LLIN (preferably a LLIN) is produced from polypropylene. Preferrably as described in WO2009/121580A2, WO2011/128380A1 and WO2011/141260A1. In a preferred embodiment of the invention, the ITN, LLINs are produced from multifilaments that have at least 48 filaments, more preferably at least 60 filaments and most preferably at least 100 filaments.

In another preferred embodiment of the invention, an active ingredient isused to control insecticide-resistant mosquitoes and/or bed bugs, preferably with a base material such as a polyolefin, polyester and/or polyamide via the contact and gaseous phase (without any additional addition of heat beyond the existing ambient temperature). Contact phase means that the mosquitoes and/or bed bugs come into direct contact with the active ingredients of the invention on the base material whereas gaseous phase means that the active ingredient of the invention are released from the base material and contact (and control) the mosquitoes and/or bed bugs via the gaseous phase (vapour phase).

Another embodiment of the invention refers to a method to control insecticide-resistant mosquitoes by using an active ingredient as discussed herein.

According to the present invention, the term “knock-down” describes the state of an animal on its back or side, which is still capable of uncoordinated movement including short periods of flying.

According to the present invention, the term “mortality” describes an immobile state of animal on its back or side.

### EXAMPLES

### 1. Efficiency of Transfluthrin Against Aedes aegypti

### Solvent: Acetone

To produce a suitable preparation Transfluthrin was dissolved in acetone. The active compound solution was pipetted onto a glazed tile and, after drying, adult mosquitoes of the species Aedes aegypti (target-site-resistant strain: Grand Cayman) were placed onto the treated tile. The exposition time was 30 minutes.

0.25 hours, 0.5 hours, 1 hour, 2 hour, 3 hour, 4 hour and 24 hours after contact to the treated surface, the knock-down proportion of the test animals in % was determined. Here, 100% (effect) means that all mosquitoes have been killed; 0% (effect) means that none of the mosquitoes have been killed.

TABLE 1
Transfluthrin/Aedes aegypti Grand Cayman

| Tested Active | Concentra- | | Hours after contact to the treated surface | | | | | | |
|---|---|---|---|---|---|---|---|---|---|
| Ingredients | tion/g/ha | | 0.25 h | 0.5 h | 1 h | 2 h | 3 h | 4 h | 24 h |
| Transfluthrin | 200 | Effect % | 100 | 100 | 100 | 100 | 100 | 100 | 100 |
| | 40 | Effect % | 100 | 100 | 100 | 100 | 100 | 100 | 100 |
| | 8 | Effect % | 90 | 100 | 100 | 90 | 100 | 90 | 90 |
| | 1.6 | Effect % | 70 | 60 | 70 | 70 | 65 | 60 | 70 |
| | 0.32 | Effect % | 20 | 25 | 30 | 20 | 20 | 25 | 20 |
| | 0.064 | Effect % | 5 | 0 | 0 | 0 | 0 | 0 | 10 |

### 2. Efficiency of Transfluthrin Against Anopheles gambiae and Anopheles funestus

### Solvent: Acetone

To produce a suitable preparation Transfluthrin was dissolved in acetone. The active compound solution was pipetted onto a glazed tile and, after drying, adult mosquitoes of the species:
Anopheles gambiae (target-site-resistant and metabolic-resistant strain: RSPH),
Anopheles gambiae (target-site-resitant and metabolic-resistant strain: Tiassalé),
Anopheles gambiae (tar et-site-resitant and metabolic-resistant strain: Akron),
Anopheles gambiae (target-site-resistant strain: VK7), and
Anopheles funestus (metabolic-resistant strain FUMOZ-R)
   were placed onto the treated tile (each strain was tested on separate tiles). The exposition time was 30 minutes.

0.25 hours, 0.5 hours, 1 hour, 2 hour, 3 hour, 4 hour and 24 hours after contact to the treated surface, the knock-down proportion of the test animals in % was determined. Here, 100% (effect) means that all mosquitoes have been killed; 0% (effect) means that none of the mosquitoes have been killed.

TABLE 2
Transfluthrin/Anopheles gambiae RSPH

| Tested Active | Concentra- | | Hours after contact to the treated surface | | | | | | |
|---|---|---|---|---|---|---|---|---|---|
| Ingredients | tion/g/ha | | 0.25 h | 0.5 h | 1 h | 2 h | 3 h | 4 h | 24 h |
| Transfluthrin | 200 | Effect % | 100 | 100 | 100 | 100 | 100 | 100 | 100 |
| | 40 | Effect % | 100 | 100 | 100 | 100 | 100 | 100 | 100 |
| | 8 | Effect % | 100 | 100 | 100 | 100 | 100 | 100 | 100 |
| | 1.6 | Effect % | 100 | 100 | 100 | 100 | 100 | 100 | 100 |
| | 0.32 | Effect % | 10 | 25 | 25 | 35 | 55 | 40 | 60 |
| | 0.064 | Effect % | n.d | n.d | n.d. | n.d. | n.d. | n.d. | n.d. |

TABLE 3
Transfluthrin/Anopheles gambiae Tiassalé

| Tested Active | Concentra- | | Hours after contact to the treated surface | | | | | | |
|---|---|---|---|---|---|---|---|---|---|
| Ingredients | tion/g/ha | | 0.25 h | 0.5 h | 1 h | 2 h | 3 h | 4 h | 24 h |
| Transfluthrin | 200 | Effect % | 100 | 100 | 100 | 100 | 100 | 100 | 85 |
| | 40 | Effect % | 100 | 100 | 100 | 95 | 90 | 85 | 85 |
| | 8 | Effect % | 90 | 100 | 100 | 85 | 80 | 85 | 60 |
| | 1.6 | Effect % | 0 | 15 | 10 | 5 | 5 | 0 | 10 |
| | 0.32 | Effect % | 5 | 15 | 5 | 10 | 10 | 10 | 15 |
| | 0.064 | Effect % | 5 | 10 | 15 | 15 | 15 | 10 | 20 |

TABLE 4
Transfluthrin/Anopheles gambiae Akron

| Tested Active | Concentra- | | Hours after contact to the treated surface | | | | | | |
|---|---|---|---|---|---|---|---|---|---|
| Ingredients | tion/g/ha | | 0.25 h | 0.5 h | 1 h | 2 h | 3 h | 4 h | 24 h |
| Transfluthrin | 200 | Effect % | 100 | 100 | 100 | 100 | 100 | 100 | 100 |
| | 40 | Effect % | 100 | 100 | 100 | 100 | 100 | 100 | 100 |
| | 8 | Effect % | 90 | 100 | 100 | 95 | 90 | 90 | 75 |
| | 1.6 | Effect % | 5 | 15 | 5 | 10 | 10 | 5 | 15 |
| | 0.32 | Effect % | 5 | 0 | 5 | 5 | 10 | 5 | 10 |
| | 0.064 | Effect % | 5 | 5 | 10 | 10 | 5 | 5 | 15 |

TABLE 5
Transfluthrin/Anopheles gambiae VK7

| Tested Active | Concentra- | | Hours after contact to the treated surface | | | | | | |
|---|---|---|---|---|---|---|---|---|---|
| Ingredients | tion/g/ha | | 0.25 h | 0.5 h | 1 h | 2 h | 3 h | 4 h | 24 h |
| Transfluthrin | 200 | Effect % | 100 | 100 | 100 | 100 | 100 | 100 | 100 |
| | 40 | Effect % | 100 | 100 | 100 | 100 | 100 | 100 | 100 |
| | 8 | Effect % | 100 | 100 | 100 | 100 | 100 | 100 | 100 |
| | 1.6 | Effect % | 80 | 90 | 85 | 80 | 65 | 85 | 65 |
| | 0.32 | Effect % | 25 | 35 | 20 | 20 | 20 | 25 | 30 |
| | 0.064 | Effect % | 5 | 5 | 5 | 15 | 15 | 15 | 25 |

TABLE 6
Transfluthrin/Anopheles gambiae FUMOZ-R

| Tested Active | Concentra- | | Hours after contact to the treated surface | | | | | | |
|---|---|---|---|---|---|---|---|---|---|
| Ingredients | tion/g/ha | | 0.25 h | 0.5 h | 1 h | 2 h | 3 h | 4 h | 24 h |
| Transfluthrin | 200 | Effect % | 100 | 100 | 100 | 100 | 100 | 100 | n.d |
| | 40 | Effect % | 100 | 100 | 100 | 100 | 100 | 100 | n.d |
| | 8 | Effect % | 100 | 100 | 100 | 100 | 100 | 100 | n.d |
| | 1.6 | Effect % | 100 | 100 | 100 | 100 | 95 | 100 | n.d |
| | 0.32 | Effect % | 95 | 100 | 100 | 60 | 40 | 40 | n.d |
| | 0.064 | Effect % | n.d | n.d | n.d | n.d | n.d | n.d. | n.d |

### 3. Efficiency of Samples with Embedded Transfluthrin (Granule, Foil, Yarn and Fabric) Against Anopheles funestus (Via Contact Phase)

Polypropylene granules (Basell, PP Metocene HM 562S) comprising 1 wt % Transfluthrin and 2 wt % bumetrizole were manufactured via extrusion with a compounding extruder at a temperature of 180° C. Polypropylene Foils (PP-Polymer Metocen HM562S (Basell) comprising 1 wt % Transflutrin were manufactured according to the method described in WO2011/128380A1.

Polypropylene Yarn (PP-Polymer Metocen HM562S (Basell) with 1 wt % Transfluthrin was manufactured starting from a masterbatch with PP-Polymer Metocen HM562S (Basell) and 1 wt % Transfluthrin and melt spinning such a masterbatch on a FDY spinning-drawing machine comprising a 30 mm extruder with 3 zone screws (25D, from Fa. Blaschke) and a spinning-drawing device (from Retech) in combination with a POY toiler (SW 46) and two cold godets (from Oelikon Barmag). The temperatures during the melt spinning process were between 192 and 233° C.

Polypropylene Fabrics (PP-Polymer Metocen HM562S (Basell)) with 1 wt % Transfluthrin were manufactured as described in WO2011/141260A1.

Tests are done using standard WHO cones with 3 minutes exposure time of the samples (granule, foil, yarn and fabric). In order to stick to this short exposure, batches of only 5 insects were introduced in cones at a time. 4 cones were operated on the same sample. After the exposure of 3 minutes, females were grouped in plastic cubs. Percentage of knock-down (KD) was noted after 60 minutes. After testing, the plastic cups with the mosquitoes were provided with a sugar water solution. Percentage of mortality (MO) was recorded after 24 hours.

The samples were also tested after a certain number of washing according to the same cone test as described above. The samples (granule, foil, yarn and fabric) were washed according the WHOPES directive (directive “Guidelines for laboratory and field testing of long-lasting insecticidal mosquito nets”, 2005;), as follows: each sample was introduced into a 1 litre beaker containing 0.5 litres of deionized water and 2 g/l of “Savon de Marseille” soap (pH 10-11, Le Chat, Henkel, France) added just before the samples and fully dissolved in the deionized water. After addition of the samples, the beaker was immediately introduced into a warm water bath at 30° C. and shaken for 10 minutes at 155 movements per minute. The samples were then removed from the beaker and rinsed twice for 10 minutes at a time with clean, deionized water in the same shaking conditions as mentioned above. Thereafter, the samples were dried at room temperature and stored at 30° C. in the dark between the washings.

Results of the Test are summerized in Table 7. According to the WHOPES directive “Guidelines for testing mosquito adulticides for indoor residual spraying and treatment of mosquito nets” (see http://www.who.int/whopes/guidelines/en/) the WHO criteria are fulfilled when one or both of the following are fulfilled: knock down (KD) is higher or equals 95% after 1 hour; mortality is higher or equals 80% after 24 hours. As indicated in table 7 the WHO criterias are fulfilled for all samples before washing occurs. The WHO criterias are also fulfilled for all samples (expect for the polypropylene yarn) after several washings. This is a clear indication that Transfluthrin is useful to control insecticide resistant mosquitoes also when Transfluthrin is embedded in polymeric materials.

TABLE 7
Contact efficacy of granule, foil, yarn and fabric
with embedded Transfluthrin against Anopheles funestus
FUMOZ-R (n.d. means not determined).

| Samples | | | | | | | |
|---|---|---|---|---|---|---|---|
| Number of | | Efficacy after Number of washings | | | | | |
| Washings: | | 0 | 1 | 2 | 3 | 4 | 5 |
| Polypropylene | KD(%) | 100 | 100 | 100 | 100 | 100 | 100 |
| Granule with | MO(%) | 100 | 94 | 97 | 100 | 90 | 92 |
| 1 wt % | | | | | | | |
| Transfluthrin | | | | | | | |
| Polypropylene | KD(%) | 100 | 100 | 95 | 95 | 100 | 95 |
| Foil with | MO(%) | 100 | 88 | 67 | 92 | 86 | 62 |
| 1 wt % | | | | | | | |
| Transfluthrin | | | | | | | |
| Polypropylene | KD(%) | 100 | 30 | 18 | n.d. | 71 | n.d. |
| Yarn with | MO(%) | 54 | 0 | 1 | n.d. | 34 | n.d. |
| 1 wt % | | | | | | | |
| Transfluthrin | | | | | | | |
| Polypropylene | KD(%) | 100 | 100 | 100 | 100 | 100 | 100 |
| Fabric with | MO(%) | 97 | 100 | 100 | 95 | 95 | 86 |
| 1 wt % | | | | | | | |
| Transfluthrin | | | | | | | |

KD = knock down after 1 h,
MO = mortality after 24 h

### 4. Efficiency of Samples with Embedded Transfluthrin (Granule, Yarn, Foil and Fabric) Against Anopheles funestus (FUMOZ-R) (Via Gaseous Phase)

Samples were manufactured as described above in example 3. Efficacy tests were done using the following set up:

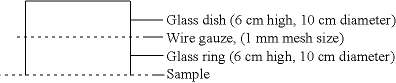

20 female mosquitoes (Anopheles funestus FUMOZ-R) were introduced between glass dish and wire gauze via an aspirator.

After an exposure time of 3 minutes, the glass dishes with the wire gauze were removed and the mosquitoes were grouped in plastic cups. Percentage knock-down (KD) was noted after 1 hour. After testing, the plastic cups with the mosquitoes were provided with sugar water solution. Percentage mortality (MO) was recorded after 24 hours. Each test consisted of two replicates of which the mean values were calculated.

The samples were tested after 2 and 5 times of washing according to the washing procedure as described in example 3.

TABLE 8
Efficacy via gaseous phase of granule, foil, yarn and fabric with
embedded Transfluthrin against Anopheles funestus FUMOZ-R.

| | KD = knock down | Number of | |
|---|---|---|---|
| | after 1 h, MO = | Washings: | |
| Samples | mortality after 24 h | 2 | 5 |
| Polypropylene Granule with | KD (%) | 96 | 64 |
| 1 wt % Transfluthrin | MO (%) | 98 | 31 |
| Polypropylene Foil with 1 wt % | KD (%) | 89 | 49 |
| Transfluthrin | MO (%) | 77 | 43 |
| Polypropylene Yarn with 1 wt % | KD (%) | 33 | n.d. |
| Transfluthrin | MO (%) | 51 | n.d. |
| Polypropylene Fabric with | KD (%) | 96 | 36 |
| 1 wt % Transfluthrin | MO (%) | 89 | 52 |

The data in table 8 indicates that Transfluthrin embeeded in a base material is even efficient via the gaseous phase against insecticide-resistant mosquitoes of Anopheles funestus FUMOZ. The data also shows that Transfluthrin is still effective after several washings.

### 5. Efficiency of Transfluthrin Against Bed Bugs (Cimex Lectularius, Strain Cincinnati (CIN-1)

To produce a suitable preparation Transfluthrin was dissolved in acetone in various concentrations (0.1 mg Transfluthrin/ml; 0.01 mg Transfluthrin/ml and 0.001 mg Transfluthrin/ml). Efficacy tests were done by placing 10 bed bug test animals (Cimex Lectularius, strain Cincinnati (CIN-1)) onto a glazed tile. The prepared solutions in various concentractions were sprayed with a glass nozzle onto the bed bugs on the glazed tile. After spraying the bed bugs were transferred to plastic cups. 5 minutes, 10 minutes, 15 minutes, 20 minutes, 0.5 hour, 1 hour, 2 hour, 4 hour and 24 hours after the treatment, the knock-down proportion of the test animals was determined.

TABLE 9
Efficacy of Transfluthrin against Cimex
Lectularius, strain Cincinnati (CIN-1).

Time after Spray

| Treatment | Amount of animals that are knocked down/killed | | | | | | | | |
|---|---|---|---|---|---|---|---|---|---|
| (in Minutes) | 5 | 10 | 15 | 20 | 30 | 60 | 120 | 240 | 1440 |
| 0.1 mg | n.d. | 9 | 10 | 10 | 10 | 10 | 10 | 10 | 9 |
| Transfluthrin/ | | | | | | | | | |
| ml Aceton | | | | | | | | | |
| 0.01 mg | n.d. | 6 | 9 | 10 | 10 | 10 | 10 | 10 | 7 |
| Transfluthrin/ | | | | | | | | | |
| ml Aceton | | | | | | | | | |
| 0.001 mg | n.d. | 0 | 0 | 0 | 0 | 1 | 1 | 0 | 3 |
| Transfluthrin/ | | | | | | | | | |
| ml Aceton | | | | | | | | | |
| Untreated Control | n.d. | 0 | 0 | 0 | 0 | 0 | 0 | 0 | 1 |

Table 9 shows that Transfluthrin is also efficient against an insecticide-resistant bed bug strain.

### 6. Efficiency of Metofluthrin Against Anopheles Kambiae, Anopheles funestus and Culex quinquefasciatus

Similarly as outlined in example 2 for Transfluthrin, Metofluthrin efficacy was assessed against
Anopheles gambiae (target-site-resistant and metabolic-resistant strain: RSPH),
Anopheles funestus (metabolic-resistant strain FUMOZ-R), and
Culex quinquefasciatus (metabolic-resistant to DDT; strain P00),
   with the results shown in Tables 10 to 12. 0.25 hours, 0.5 hours, 1 hour, 2 hour, 3 hour, 4 hour and 24 hours after contact to the treated surface, the knock-down proportion of the test animals in % is depicted in Tables 10 to 12. 100% (effect) means that all mosquitoes have been killed; 0% (effect) means that none of the mosquitoes have been killed.

TABLE 10
Metofluthrin/Anopheles gambiae RSPH

| Tested Active | Concentra- | | Hours after contact to the treated surface | | | | | | |
|---|---|---|---|---|---|---|---|---|---|
| Ingredients | tion/g/ha | | 0.25 h | 0.5 h | 1 h | 2 h | 3 h | 4 h | 24 h |
| Metofluthrin | Control (0) | Effect % | 5 | 0 | 0 | 0 | 5 | 5 | 35 |
| | 1000 | Effect % | 100 | 100 | 100 | 100 | 100 | 100 | 100 |
| | 200 | Effect % | 100 | 100 | 100 | 100 | 100 | 100 | 100 |
| | 40 | Effect % | 100 | 100 | 100 | 100 | 100 | 100 | 100 |
| | 8 | Effect % | 100 | 100 | 100 | 100 | 100 | 100 | 100 |
| | 1.6 | Effect % | 100 | 100 | 100 | 100 | 100 | 100 | 100 |
| | 0.32 | Effect % | 0 | 10 | 10 | 10 | 0 | 10 | 20 |
| | 0.064 | Effect % | 0 | 0 | 0 | 0 | 0 | 10 | 20 |

TABLE 11
Metofluthrin/Anopheles gambiae FUMOZ-R

| Tested Active | Concentra- | | Hours after contact to the treated surface | | | | | | |
|---|---|---|---|---|---|---|---|---|---|
| Ingredients | tion//ha | | 0.25 h | 0.5 h | 1 h | 2 h | 3 h | 4 h | 24 h |
| Metofluthrin | Control (0) | Effect % | 0 | 0 | 0 | 0 | 0 | 0 | 15 |
| | 1000 | Effect % | 100 | 100 | 100 | 100 | 100 | 100 | 100 |
| | 200 | Effect % | 100 | 100 | 100 | 100 | 100 | 100 | 100 |
| | 40 | Effect % | 100 | 100 | 100 | 100 | 100 | 100 | 100 |
| | 8 | Effect % | 100 | 100 | 100 | 100 | 100 | 100 | 100 |
| | 1.6 | Effect % | 90 | 100 | 100 | 80 | 40 | 40 | 70 |
| | 0.32 | Effect % | 0 | 0 | 0 | 0 | 0 | 0 | 10 |
| | 0.064 | Effect % | 0 | 0 | 0 | 0 | 0 | 0 | 20 |

TABLE 12
Metofluthrin/Culex quinquefasciatus P00,

| Tested Active | Concentra- | | Hours after contact to the treated surface | | | | | | |
|---|---|---|---|---|---|---|---|---|---|
| Ingredients | tion//ha | | 0.25 h | 0.5 h | 1 h | 2 h | 3 h | 4 h | 24 h |
| Metofluthrin | Control (0) | Effect % | 0 | 0 | 0 | 0 | 0 | 0 | 15 |
| | 1000 | Effect % | 100 | 100 | 100 | 100 | 100 | 100 | 100 |
| | 200 | Effect % | 100 | 100 | 100 | 100 | 100 | 100 | 100 |
| | 40 | Effect % | 100 | 100 | 100 | 100 | 100 | 100 | 100 |
| | 8 | Effect % | 100 | 100 | 100 | 100 | 100 | 100 | 100 |
| | 1.6 | Effect % | 90 | 100 | 100 | 100 | 100 | 100 | 100 |
| | 0.32 | Effect % | 0 | 0 | 0 | 0 | 0 | 0 | 10 |
| | 0.064 | Effect % | 0 | 0 | 0 | 0 | 0 | 0 | 0 |

### 7. Efficiency of Momfluorothrin Against Anopheles gambiae and Anopheles funestus

Similarly as outlined in example 2 for Transfluthrin, Metofluthrin efficacy was assessed against
Anopheles gambiae (target-site-resistant and metabolic-resistant strain: RSPH),
Anopheles funestus (metabolic-resistant strain FUMOZ-R), and
   with the results shown in Tables 13 to 12. 0.25 hours, 0.5 hours, 1 hour, 2 hour and 3 hours after contact to the treated surface, the knock-down proportion of the test animals in % is depicted in Tables 13 to 14. 100% (effect) means that all mosquitoes have been killed; 0% (effect) means that none of the mosquitoes have been killed.

TABLE 13
Momfluorothrin/Anopheles gambiae RSPH

| Tested Active | Concentra- | | Hours after contact to the treated surface | | | | |
|---|---|---|---|---|---|---|---|
| Ingredients | tion/g/ha | | 0.25 h | 0.5 h | 1 h | 2 h | 3 h |
| Momfluorothrin | Control (0) | Effect % | 0 | 0 | 0 | 0 | 0 |
| | 40 | Effect % | 100 | 100 | 100 | 100 | 100 |
| | 1.6 | Effect % | 10 | 7 | 35 | 14 | 14 |

TABLE 14
Momfluorothrin/Anopheles gambiae FUMOZ-R

| Tested Active | Concentra- | | Hours after contact to the treated surface | | | | |
|---|---|---|---|---|---|---|---|
| Ingredients | tion/g/ha | | 0.25 h | 0.5 h | 1 h | 2 h | 3 h |
| Momfluorothrin | Control (0) | Effect % | 0 | 0 | 0 | 0 | 0 |
| | 40 | Effect % | 100 | 100 | 100 | 90 | 100 |
| | 1.6 | Effect % | 0 | 0 | 0 | 10 | 20 |

1. An insecticidal compound comprising a polyfluorobenzyl moiety to control insecticide-resistant mosquitoes and/or bed bugs wherein the insecticide resistant mosquitoes are resistant to at least one insecticide selected from the group consisting of pyrethroids, organophosphates and carbamates, and further wherein the insecticidal compound comprising a polyfluorobenzyl moiety is capable of being used alone and not in combination with another insecticide to control insecticide-resistant mosquitoes and/or bed bugs.

2. An insecticidal compound according to claim 1, wherein the compound comprising a polyfluorobenzyl moiety is selected from the group consisting of Transfluthrin, Metofluthrin, Momfluorothrin, Meperfluthrin, Dimefluthrin, Fenfluthrin, Profluthrin, Tefluthrin and Heptafluthrin.

3. An insecticidal compound according to claim 1, the compound comprising a polyfluorobenzyl moiety is selected from the group consisting of Transfluthrin and Metofluthrin.

4. An insecticidal compound according to claim 1, wherein the insecticide-resistant mosquitoes and/or bed bugs are resistant against at least one pyrethroid insecticide that does not comprise a polyfluorobenzyl moiety.

5. An insecticidal compound according to claim 1 wherein the pyrethroid is selected from the group consisting of Alpha-Cypermethrin, Bifenthrin, Cyfluthrin, Cypermethrin, Deltamethrin, D-D Trans-Cyphenothrin Esfenvalerate, Etofenprox, Lambda-Cyhalothrin, Permethrin, Pyrethrins (Pyrethrum), Phenothrin, and Zeta-Cypermethrin.

6. An insecticidal compound according to claim 5 wherein the pyrethroid is selected from the group consisting of Cyfluthrin, Cypermethrin, Deltamethrin, Lambda-Cyhalothrin and Permethrin.

7. An insecticidal compound according to claim 1, wherein the insecticide-resistant mosquitoes are selected from the group consisting of Anopheles gambiae, Anopheles funestus, Aedes aegypti and Culex spp.

8. An insecticidal compound according to claim 7 wherein the insecticide-resistant mosquitoes are selected from the group consisting of Anopheles gambiae RSPH, Anopheles gambiae Tiassalé, Anopheles funestus FUMOZ-R, Anopheles gambiae Akron, Anopheles gambiae VK7 and Aedes aegypti Grand Cayman.

9. An insecticidal compound according to claim 1 wherein the insecticide-resistant bed bugs have a Valine to Leucine mutation (V419L) and/or a Leucine to Isoleucine mutation (L925I) in the voltage-gated sodium channel alpha-subunit gene.

10. A compound comprising a polyfluorobenzyl moiety according to claim 1 capable of being used for vector control.

11. A compound comprising a polyfluorobenzyl moiety according to claim 10 capable of being used for an indoor residual spray, an insecticide treated net, a longer lasting insecticide net, a space spray and/or a spatial repellent.

12. A compound comprising a polyfluorobenzyl moiety according to claim 1 together with a base material.

13. A compound with a base material according to claim 12 wherein the base material is selected from the group consisting of a polymer(s), plant-based material(s), coating/impregnation solution(s) and/or mixtures thereof.

14. A compound together with a base material according to claim 13 wherein the polymer is selected from the group consisting of polyolefine, polyester and/or polyamides and wherein the compound comprising a polyfluorobenzyl moiety is used together with the polymer for an insecticide treated net and/or a longer lasting insecticidal net.

15. A compound together with a base material according to claim 12 wherein the compound comprising a polyfluorobenzyl moiety together with the base material controls insecticide-resistant mosquitoes via contact and gaseous phase.
